(19) United States
(12) Patent Application Publication
(10) Pub. No.: US 2022/0055326 A1
(43) Pub. Date: Feb. 24, 2022

(54) METHOD AND DEVICE FOR MANUFACTURING AN OPHTHALMIC LENS

(71) Applicant: ESSILOR INTERNATIONAL, CHARENTON-LE-PONT (FR)

(72) Inventors: Sébastien MAURICE, CHARENTON-LE-PONT (FR); Frédéric DUBOIS, CHARENTON-LE-PONT (FR); Benoit CALLIER, CHARENTON-LE-PONT (FR); Florent DELOISON, TALENCE (FR); Bruno CHASSAGNE, TALENCE (FR); Clémentine JAVAUX-LEGER, TALENCE (FR); Bastien ANCELOT, TALENCE (FR)

(21) Appl. No.: 17/312,448

(22) PCT Filed: Dec. 12, 2019
(86) PCT No.: PCT/EP2019/084914

§ 371 Date: Jun. 10, 2021

(30) Foreign Application Priority Data
Dec. 12, 2018 (EP) 18306678.6

(51) Int. Cl. B29D 11/00; G02C 7/02; B23K 26/53; B23K 26/00; B23K 26/0622

(52) U.S. Cl. CPC B29D 11/00461; G02C 7/022; B23K 26/53; B23K 2103/42; B23K 26/0624; G02C 2202/12; G02C 2202/20; B23K 26/0006

(57) ABSTRACT

Disclosed are a method and device for manufacturing an ophthalmic lens for eyeglasses intended to be placed in front of an eye of a wearer, the ophthalmic lens having a desired optical function including a dioptric function adapted to a prescription of the wearer. The method includes: providing an optical element made of a first material having a first refractive index, the optical element being intended to be modified to manufacture the ophthalmic lens; providing data relative to the modification of the optical element enabling to obtain the desired optical function; determining at least one zone in the first material based on data; and modifying the refractive index of the first material to form a pattern in the determined zone with focused femtosecond laser pulses according to data so as to obtain an ophthalmic lens having the desired optical function.

### BACKGROUND OF THE INVENTION

### Field of the Invention

The present invention relates to a method for manufacturing an ophthalmic lens for eyeglasses intended to be placed in front of an eye of a wearer, in particular intended to be mounted within eyeglasses, and to a corresponding device. The invention further relates to an ophthalmic lens manufactured by the device and/or according to the method.

### Description of the Related Art

An ophthalmic lens is typically made of plastic or glass material and generally has two opposing surfaces which co-operate to provide a required corrective prescription. Such material is solid and rigid.

Manufacturing of an ophthalmic lens to the required prescription requirements typically includes machining a face of a semi-finished lens. Typically, a semi-finished lens has a finished face, for example the front face and an unfinished face, for example the back face. By machining the back face of the lens to remove material, the required shape and positioning of the surface of the back face with respect to the surface of the front face for the desired corrective prescription can be generated.

### SUMMARY OF THE INVENTION

A goal of the present invention is to provide an alternative to classical method for manufacturing an ophthalmic lens.

To this end, the invention proposes a method for manufacturing an ophthalmic lens for eyeglasses intended to be placed in front of an eye of a wearer, the ophthalmic lens having a desired optical function comprising a dioptric function adapted to a prescription of the wearer, the method comprising:
providing an optical element made of a first material having a first refractive index, the optical element being intended to be modified to manufacture the ophthalmic lens,
providing data relative to the modification of the optical element enabling to obtain the desired optical function,
determining at least one zone in the first material based on data, and
modifying the refractive index of the first material in the determined zone with focused femtosecond laser pulses according to data so as to obtain an ophthalmic lens having the desired optical function.

Advantageously, such a method according to the invention allows a functionalizing internal marking that is to say, a marking in the mass that will create an optical function or add an additional optical function to the optical element, using laser marking generating a change of the index of the material.

According to further embodiments which can be considered alone or in combination:
the data comprise:
   data relative to variation of spherical, cylinder and/or prismatic power to be applied to the optical element, and/or
   data relative to variation of the optical design to be applied to the optical element, and/or
   data relative to an additional dioptric function to be applied to the optical element;
the modifying step comprises a pattern forming step, wherein a pattern is formed in the determined zone of the first material by the focusing of the femtosecond laser pulses in the determined zone;
the pattern comprises superimposed Fresnel layers;
the pattern comprises an interferential element, preferably an antireflective coating or a reflective coating or an hologram or an optical waveguide;
the optical element is an initial ophthalmic lens having an initial optical function adapted to a previous prescription of the wearer and the refractive index of the first material is modified so as to obtain an ophthalmic lens having the desired optical function adapted to the current prescription of the wearer;
the method further comprises:
   determining the optical element;
   determining data relative to the modification of the optical element enabling to obtain the desired optical function based at least on the measurement so as to obtain an ophthalmic lens having a dioptric function adapted to the current prescription to 0.25 Diopters or less than 0.25 Diopters;
the optical element is a semi-finished lens blank or a lens blank comprising a front face and a back face opposed to the front face, the back face being the face intended to be the closest to the wearer's eye when the ophthalmic lens is placed in front of the wearer's eye;
during the modifying step, the femtosecond laser pulses are focused in the determined zone through the front face of the optical element;
the determined zone is a tridimensional zone defining a plurality of layers wherein the refractive index is modified during the modifying step, each layer being substantially parallel to the front face and localized at an average distance from the front face, and during the modification step, the refractive index of the first material in the determined zone is successively modified with focused femtosecond laser pulses from the most distant layers of the front face to the least distant layers of the front face;
the wavelength of the femtosecond laser pulses is comprised between 500 nm and 550 nm, preferably between 510 nm and 520 nm, advantageously equal to 515 nm;
the size of the focused femtosecond laser pulses is comprised between 0.5 μm and 1.5 μm;
the method further comprises:
   providing a first ophthalmic lens having a first optical function and comprising a first face and a second face opposed to the first face, the second face being the face intended to be the closest to the wearer's eye when the first ophthalmic lens is placed in front of the wearer's eye; and
   after the modifying step, adding the modified optical element to the first ophthalmic lens so as to form the ophthalmic lens having a desired optical function adapted to the wearer;
wherein the modified optical element is the optical element wherein the refractive index of the first material in the determined zone is modified with focused femtosecond laser pulses according to data.
the method further comprises:
   applying the pattern to peripheral regions of the lens, and
   leaving a center region of the lens free of such pattern, the center region being intended to be in front of a pupil of the wearer once mounted within a headwear and worn by the wearer;
such center region is intended to correspond to a zone predetermined to be a far vision (FV) zone of the lens as commonly defined in ophthalmic;
such center region is a region along the optical axis of the lens;
the method further comprises applying the pattern in a bottom part of the lens corresponding to a zone predetermined to be a near vision (NV) zone of the lens;
the method further comprises: applying the pattern such that it forms a multiplicity of optical elements, each optical elements of the multiplicity of optical elements individually having a dioptric function.

The invention further relates to an ophthalmic lens for eyeglasses intended to be placed in front of an eye of a wearer, the ophthalmic lens having a desired optical function comprising a dioptric function adapted to a prescription of the wearer and being manufactured from an optical element made of a first material having a first refractive index by modifying the refractive index with focused femtosecond laser pulses so as to obtain the ophthalmic lens having the desired optical function.

According to a preferred embodiment, the ophthalmic lens is manufactured according to a method of manufacturing according to the invention and as described hereinbefore.

Another object of the invention relates to an apparatus for manufacturing an ophthalmic lens for eyeglasses intended to be placed in front of an eye of a wearer, the ophthalmic lens having a desired optical function comprising a dioptric function adapted to a prescription of the wearer, the apparatus comprising:
means for providing an optical element made of a first material having a first refractive index, the optical element being intended to be modified to manufacture the ophthalmic lens,
means for providing data relative to the modification of the optical element enabling to obtain the desired optical function,
means for determining at least one zone in the first material based on data, and
means for modifying the refractive index of the first material in the determined zone with focused femtosecond laser pulses according to data so as to obtain an ophthalmic lens having the desired optical function.

According to a preferred embodiment, the apparatus is adapted to implement a method of manufacturing according to the invention and as described hereinbefore.

According to a further aspect, the invention further relates to a device comprising a processor adapted to store one or more sequence of instructions and to carry out at least one of the steps of the method according to the invention.

More particularly, the invention relates to a computer program product comprising one or more stored sequences of instructions that are accessible to a processor and which, when executed by the processor, causes the processor to carry out at least the following steps of the method according to the invention:
providing an optical element made of a first material having a first refractive index, the optical element being intended to be modified to manufacture the ophthalmic lens,
providing data relative to the modification of the optical element enabling to obtain the desired optical function,
determining at least one zone in the first material based on data, and
controlling a femtosecond laser for modifying the refractive index of the first material in the determined zone with focused femtosecond laser pulses according to data so as to obtain an ophthalmic lens having the desired optical function.

The invention further relates to a computer readable medium carrying one or more sequences of instructions of the computer program product according to the invention.

Unless specifically stated otherwise, as apparent from the following discussions, it is appreciated that throughout the specification discussions utilizing terms such as “computing”, “calculating”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer or Digital Signal Processor (“DSP”) selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

### BRIEF DESCRIPTION OF THE DRAWINGS

Embodiments of the invention will now be described, by way of example only, and with reference to the following drawings in which:

FIG. 1 is schematic view of a device for manufacturing an ophthalmic lens for eyeglasses from an optical element according to the invention;

FIG. 2 is a flowchart of the steps of an embodiment of the method for manufacturing an ophthalmic lens according to the invention;

FIG. 3 is a flowchart of the steps of another embodiment of the method for manufacturing an ophthalmic lens according to the invention;

FIG. 4 illustrates an example of an ophthalmic lens manufactured according to an embodiment of the invention; and

FIG. 5 illustrates an example of an ophthalmic lens manufactured according to an embodiment of the invention.

Elements in the figures are illustrated for simplicity and clarity and have not necessarily been drawn to scale. For example, the dimensions of some of the elements in the figure may be exaggerated relative to other elements to help improve the understanding of the embodiments of the present invention.

### DESCRIPTION OF THE PREFERRED EMBODIMENTS

A first aspect of the invention relates to an ophthalmic lens for eyeglasses intended to be placed in front of an eye of a wearer and having a desired optical function comprising a dioptric function adapted to a prescription of the wearer.

The ophthalmic lens for eyeglasses is herein defined as a lens which is designed to fit a spectacles frame of eyeglasses or spectacles or fixed to a headwear so as to protect the eye and/or correct the sight and can be corrective and non-corrective lenses, including single vision or multi-vision lenses, which may be either segmented or non-segmented, as well as other elements used to correct, protect, or enhance vision such as magnifying lenses and protective lenses or visors found in spectacles, glasses, goggles and helmets.

In the sense of the disclosure, an optical function corresponds to a function providing for each gaze direction the effect of an ophthalmic lens on the light ray passing through the optical lens.

The optical function may comprise dioptric function, light absorption, polarizing capability, reinforcement of contrast capacity, etc. . . .

The dioptric function corresponds to the optical lens power (mean power, astigmatism, the prismatic deviation, etc. . . . ) as a function of the gaze direction.

In the sense of the invention, the prescription is a set of optical characteristics of optical power, of astigmatism and, where relevant, of addition, determined by an ophthalmologist in order to correct/compensate the vision defects of an individual, for example by means of a lens positioned in front of his eye. Generally speaking, the prescription for a progressive addition lens comprises values of optical power and of astigmatism at the distance-vision point and, where appropriate, an addition value.

According to the invention, the ophthalmic lens is manufactured from an optical element made of a first material having a first refractive index by modifying the refractive index with focused femtosecond laser pulses so as to obtain the ophthalmic lens having the desired optical function.

The first material is a standard material for ophthalmic substrates for eyeglasses lenses. Within the meaning of the disclosure, it is any organic glass commonly used in the field of optics and in particular in the ophthalmic field for substrates of ophthalmic lenses for eyeglasses. It is, for example, composed of a thermoplastic or thermosetting plastic.

Mention may be made, by way of examples, of substrates made of polycarbonate, of polyamide, of polyimide, of polysulfone, of copolymers of poly(ethylene terephthalate) and polycarbonate, of polyolefins, in particular of polynorbornene, of homopolymers and copolymers of diethylene glycol bis(allyl carbonate), of (meth)acrylic polymers and copolymers, in particular (meth)acrylic polymers and copolymers derived from bisphenol A, of thio(meth)acrylic polymers and copolymers, of polyurethane and polythiourethane homopolymers or copolymers, epoxy polymers and copolymers and episulfide polymers and copolymers.

As non-limiting examples, it will be possible to use a diethylene glycol bis(allyl carbonate), such as CR39®, in particular with a refractive index of 1.5, sold by PPG Industries, or else a polythiourethane, such as any of the MR series sold by Mitsui Toatsu, with an example of the MR7® with a refractive index of 1.66, or a polycarbonate, which may be derived from bisphenol A, although it may alternatively be derived from other diols such as 1,1-bis(4-hydroxyphenyl)cyclohexane, dihydroxybenzophenone and tetramethylcyclobutanediol.

Examples of polycarbonates usable for the ophthalmic field and their preparation process are given in U.S. Pat. No. 3,305,520 for instance.

The substrates formed using such materials are sensibly rigid in order to be able to be mounted into frames for spectacles or eyeglasses. The lenses are mounted into such frames using mechanical interactions between parts of the substrate, shaped as bevels, trenches, or drilled holes, and corresponding trenches, threads, edges or screws.

Advantageously, the ophthalmic lens is manufactured according to a method of manufacturing according to the invention and as described hereinafter and/or by an apparatus for manufacturing an ophthalmic lens according to another aspect of the invention.

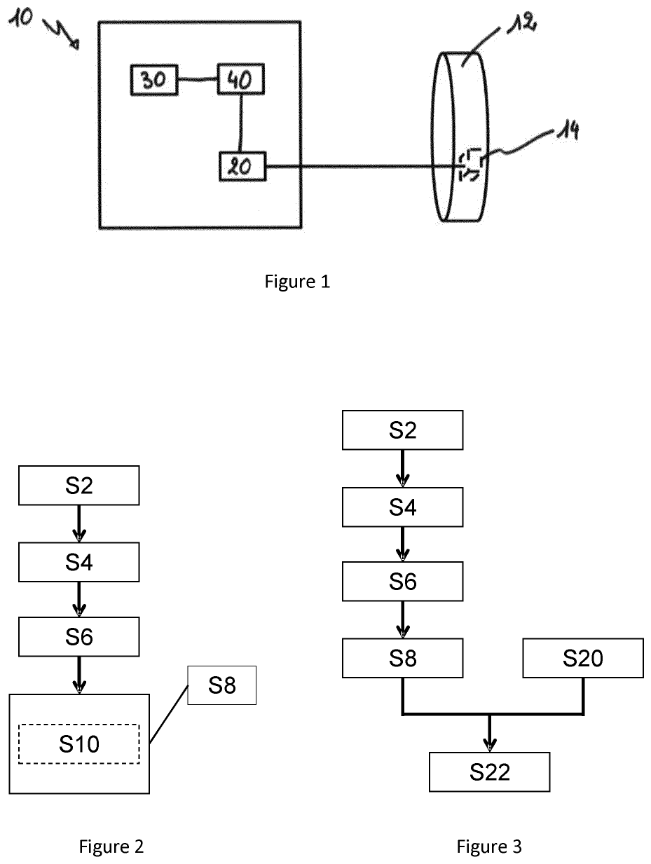

Such an apparatus for manufacturing an ophthalmic lens will now be detailed with reference to FIG. 1.

According to the invention, the apparatus 10 comprises at least means for providing an optical element 12 intended to be modified to manufacture the ophthalmic lens. The optical element 12 is made of a first material having a first refractive index.

The apparatus 10 further comprises at least means for providing data relative to the modification of the optical element 12 enabling to obtain the desired optical function.

Moreover, the apparatus comprises at least means for determining at least one zone 14 in the first material based on data. The at least one zone 14 is a volumic zone and can be a part of the optical element 12 or the optical element 12 entirely.

The apparatus 10 further comprises at least means for modifying the refractive index of the first material in the determined zone 14 with focused femtosecond laser pulses according to data so as to obtain an ophthalmic lens having the desired optical function.

The apparatus 10 also comprises means 20 for illuminating the optical element 12 and so configured to emit focused femtosecond laser pulses inside the optical element in the determined zone.

Preferably, the wavelength of the femtosecond laser pulses is comprised between 500 nm and 550 nm, preferably between 510 nm and 520 nm, advantageously equal to 515 nm.

For example, the femtosecond laser delivers pulses with a duration of 400 fs, at a repetition rate ranging from 500 kHz to 2 MHz, and with a maximum energy of 8 μJ per pulse. An external modulator (comprised in the laser) reduces the laser repetition rate up to 1 kHz. The initial wavelength of the laser beam is, for example, equal to 1030 nm. A doubler-tripler module placed at the output of the laser makes it possible to emit laser pulses at 515 nm.

Furthermore, the size of the focused femtosecond laser pulses is preferably comprised between 0.5 μm and 1.5 μm.

Advantageously, the apparatus 10 is adapted to implement a method of manufacturing according to the invention and detailed hereinafter.

For example, the apparatus 10 comprises a memory 30 and a processor 40.

The memory 30 is adapted to store one or more sequences of instructions that are accessible to the processor 40 and which, when executed by the processor, causes the processor to carry out at least the following steps:
providing the optical element 12,
providing data relative to the modification of the optical element 12 enabling to obtain the desired optical function,
determining at least one zone 14 in the first material based on data, and
controlling a femtosecond laser 20 for modifying the refractive index of the first material in the determined zone 14 with focused femtosecond laser pulses according to data so as to obtain an ophthalmic lens having the desired optical function.

As represented on FIG. 2, the invention further relates to a method for manufacturing an ophthalmic lens intended to be placed in front of an eye of a wearer. As indicated hereinbefore, the ophthalmic lens has a desired optical function comprising a dioptric function adapted to a prescription of the wearer.

The method comprises:
an optical element providing step S2;
a modification data providing step S4;
a zone determining step S6; and
a refractive index modifying step S8.

During the optical element providing step S2, an optical element intended to be modified to manufacture the ophthalmic lens is provided. The optical element is made of a first material having a first refractive index.

During the modification data providing step S4, data relative to the modification of the optical element enabling to obtain the desired optical function are provided.

Preferably, the data comprise:
data relative to variation of spherical, cylinder and/or prismatic power to be applied to the optical element, and/or
data relative to variation of the optical design to be applied to the optical element, and/or
data relative to an additional dioptric function to be applied to the optical element.

Then, at least one zone in the first material is determined based on data during the zone determining step S6.

During the refractive index modifying step S8, the refractive index of the first material is modified in the determined zone with focused femtosecond laser pulses according to data so as to obtain an ophthalmic lens having the desired optical function.

Advantageously, the wavelength of the femtosecond laser pulses is comprised between 500 nm and 550 nm, preferably between 510 nm and 520 nm, advantageously equal to 515 nm.

For example, the femtosecond laser delivers pulses with a duration of 400 fs, at a repetition rate ranging from 500 kHz to 2 MHz, and with a maximum energy of 8 μJ per pulse. An external modulator (comprised in the laser) reduces the laser repetition rate up to 1 kHz. The initial wavelength of the laser beam is, for example, equal to 1030 nm. A doubler-tripler module placed at the output of the laser makes it possible to emit laser pulses at 515 nm.

Furthermore, the size of the focused femtosecond laser pulses is comprised between 0.5 μm and 1.5 μm.

For example, the refractive index is modified as a function of the energy of the pulses of the femtosecond laser. Table 1 gives an example of the difference of refractive index Δn of the first material after and before the irradiation, as a function of the energy E of the pulses in nanojoules (nJ).

TABLE 1

| E (nJ) | Δn |
|---|---|
| 20 | −0.002 |
| 76 | −0.009 |
| 138 | −0.009 |
| 190 | −0.014 |
| 250 | −0.014 |

Preferably, the modifying step S8 comprises a pattern forming step S10, wherein a pattern is formed in the determined zone of the first material by the focusing of the femtosecond laser pulses in the determined zone.

For example, the pattern comprises superimposed Fresnel layers.

According to another example, the pattern can comprise an interferential element, preferably an antireflective coating or a reflective coating or a hologram or an optical waveguide.

According to a preferred embodiment of the invention, the optical element 12 is an initial ophthalmic lens having an initial optical function adapted to a previous prescription of the wearer.

In this embodiment, the refractive index of the first material is further modified so as to obtain an ophthalmic lens having the desired optical function adapted to the current prescription of the wearer.

Thus, the optical function of the initial ophthalmic lens can be updated based on the updated current prescription of the wearer thanks to the invention.

According to this embodiment, the method preferably further comprises:
measuring the optical element 12; or acquiring data related to the optical power of the optical element 12;
determining data relative to the modification of the optical element enabling to obtain the desired optical function based at least on the measurement so as to obtain an ophthalmic lens having a dioptric function adapted to the current prescription.

In the sense of the disclosure, having a dioptric function adapted to the current prescription means that the difference between the measured optical power at a reference point in the determined zone and the prescribed optical power is smaller or equal to 0.25 D.

During the step for determining or measuring the optical element, i.e. the initial ophthalmic lens, optical parameters can be provided or measured. Optical parameter may be defined as a parameter that may be calculated by ray tracing through the ophthalmic lens, such as power profile of the meridian, widths of iso power or astigmatism lines fields, power or astigmatism gradients, wavefront, optical flow, retinal flow, deviation maps . . . .

For example, the optical element 12 is a semi-finished lens blank or a lens blank comprising a front face and a back face opposed to the front face. The back face is the face intended to be the closest to the wearer's eye when the ophthalmic lens is placed in front of the wearer's eye.

Advantageously, the femtosecond laser pulses are focused in the determined zone 14 through the front face of the optical element 12 during the modifying step S8.

As indicated hereinbefore, the determined zone is preferably a tridimensional zone defining a plurality of layers wherein the refractive index is modified during the modifying step. Each layer is substantially parallel to the front face and localized at an average distance from the front face. The refractive index of the first material in the determined zone is advantageously successively modified with focused femtosecond laser pulses from the most distant layers of the front face to the least distant layers of the front face during the modification step S8.

According to an embodiment, the method further comprises applying the pattern to peripheral regions of the lens and leaving a center region of the lens free of such pattern. In other words, the modification of the optical element using the femtolaser pulses is limited to peripheral regions of the lens, leaving a center region of the lens free of pattern. A center region is a region of the lens intended to be in front of a pupil of the wearer once mounted within a headwear.

In particular, such center region may correspond to a zone predetermined to be a far vision (FV) zone of the lens as commonly defined in ophthalmic or such center region may correspond to a region along the optical axis of the lens. The far vision zone corresponds generally to a region of the lens intended to be in front of a pupil of the wearer once the lens is mounted in a frame and once the wearer is looking straight away at a far object.

Indeed, the inventors have noticed that using a femtolaser according to the disclosure for changing the index of the material of the ophthalmic lens, the index variation is relatively small for use in eyeglasses. Therefore, in order to form an effective additional dioptric effect it is often chosen to arrange the pattern to form Fresnel structures or the similar structures. These structures have the create defects of creating diffraction patterns. By having the structures only in periphery, the center region, which is the part of the lens the most used for activities, is free from the diffractions. In other words, the benefits of the disclosure may still be employed for parts of the lens which are used either more rarely or in environments less prone to bright lights: reading, looking inside the car instead of outside . . . . Such small defects are in particular less troubling to the user in near vision zone when the user is focusing on near objects.

According to another embodiment, the method preferably comprises applying the pattern in a bottom part of the lens corresponding to a zone predetermined to be a near vision (NV) zone of the lens. In other words, the modification of the optical element using the femtolaser pulses is limited to a bottom part of the lens corresponding to a zone predetermined to be a near vision zone of the lens. The near vision zone corresponds generally to a region of the lens intended to be in front of a pupil of the wearer once the lens is mounted in a frame and once the wearer is looking toward a near object situated below his head, e.g. around the position a book would be held.

This use of the method of the disclosure enables to personalize or amend in a late step a near vision zone of the lens. In examples of this application of this embodiment, the modification of the optical element using the femtolaser pulses of the method of the disclosure enables to create an addition zone in the near vision zone of the optical element so as to form the dioptric effects of a progressive addition lens or a bifocal or trifocal lens.

Alternatively the optical element may already be a multifocal lens, either a progressive addition lens or a bifocal or trifocal lens and the modification of the optical element using the femtolaser pulses may be used to improve or modify such addition zone or second or third focal region, either to personalize it or to correct second order defects.

According to another embodiment, the method preferably comprises applying the pattern such that it forms a multiplicity of optical elements, each optical elements of the multiplicity of optical elements individually having a dioptric function. In other words, the modification of the optical element using the femtolaser pulses forms a multiplicity of optical elements, each individually having a dioptric function.

Those structures are different from Fresnel lenses in that each having its own dioptric function they enable to provide locally a second optical power to the lens, different from a part of the lens which does not have a similar structure. Accordingly such region of the lens may comprise two different optical powers, a first optical power formed by the regions of the lens without the dioptrics elements and a second optical power formed by the multiplicity of dioptric elements. The two optical powers are both present in the same region. Such structures may be for examples used in order to help prevent myopia progression. Such dioptric structures may be formed using the method of the disclosure using patterns that would lead to have a similar optical signature as micro lenses, either separated from each other or touching each other on two or more sides, to have a similar optical signature as micro-cylindrical lenses arranged in annulus.

According to another preferred embodiment of the invention, the optical element 12 is an ophthalmic lens made of a substrate and of a HMC (Hardened and Multi Coated) having an optical function adapted to the prescription of the wearer, the HMC providing an anti-reflective function such as for example the “specter RV killer” described in WO2015000534.

In this embodiment, the refractive index of the substrate is modified so as to obtain an ophthalmic lens having an optical function adapted to the prescription of the wearer and having an interferential filter.

According to this embodiment, the method preferably comprises:
providing the optical element 12;
providing data relative to a wavelength range to filter,
determining a zone to be modified based on the data,
forming a pattern in the determined zone by the focusing of the femtosecond laser pulses in the determined zone, the pattern zone comprising multiple layers with different refractive index.

Advantageously, the femtosecond laser pulses are focused in the determined zone 14 through the front face of the optical element 12 during the modifying step S8.

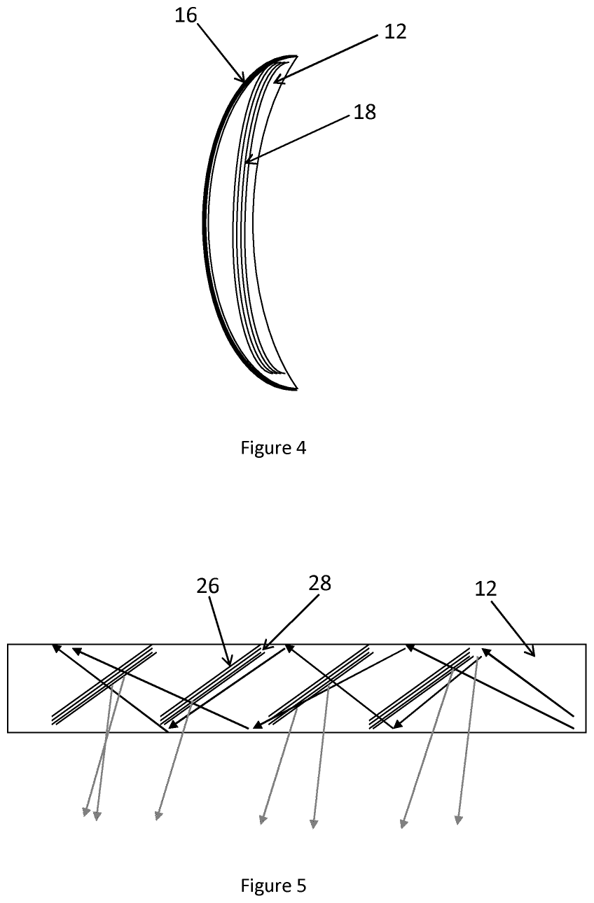

With reference to FIG. 4, the determined zone is preferably a tridimensional zone defining a plurality of layers wherein the refractive index is alternatively modified for each layer during the modifying step so as to obtain a series of layers with a low refractive index nL interposed with layers with a high refractive index nH.

Such structure formed with multiple layers of alternating refractive index corresponds to a distributed Bragg reflector. For example, a low refractive index layer can be obtained by modifying the refractive index of said layer by using the femtosecond laser and a high refractive level layer by not modifying the refractive index of said layer.

Advantageously the refractive index difference between the high refractive index layer and the low refractive index layer is small, preferably the difference is inferior or equal to 0.03, more preferably the difference is inferior or equal to 0.01.

The thickness of each low refractive index layer of such structure is equal to λ/(4·nL), and the thickness of each high refractive index layer is equal to λ/(4·nH), where A is the wavelength to be filtered.

The wavelength range Δf0 filtered by such reflector is defined by the following equation:

$$\frac{Δ {f}_{0}}{{f}_{0}} = \frac{4}{π} {sin}^{- 1} ( \frac{n L - n H}{n L + n H} )$$

The reflectivity of such structure formed with multiple layers of alternating refractive index is given by the following equation:

$$R = {[ \frac{n {H ( n L )}^{2 N} - n {H ( n H )}^{2 N}}{n {H ( n L )}^{2 N} + n {H ( n H )}^{2 N}} ]}^{2} ,$$

where N is the number of repeated pairs of layers.

Advantageously multiple reflective structures such as distributed Bragg reflector with different filtering wavelength can be defined in the determined zone to increase the filtered range.

As indicated hereinbefore, each layer is substantially parallel to the front face and localized at an average distance from the front face. The refractive index of the material in the determined zone is advantageously successively modified with focused femtosecond laser pulses from the most distant layers of the front face to the least distant layers of the front face during the modification step S8.

According to another preferred embodiment of the invention, the optical element 12 is an ophthalmic lens made of a standard material and having an optical function adapted to the prescription of the wearer.

In this embodiment, the refractive index of the substrate is modified so as to provide an optical function permitting vision of virtual image.

According to this embodiment, the method preferably comprises:
providing the optical element 12;
providing data relative to the modification of the optical element enabling to obtain an optical function permitting vision of virtual images,
determining a zone to be modified based on the data,
forming a pattern in the determined zone by the focusing of the femtosecond laser pulses in the determined zone, the pattern zone being comprised in waves guides made of parallel optical plates.

Advantageously, the femtosecond laser pulses are focused in the determined zone 14 through the front face of the optical element 12 during the modifying step S8.

With reference to FIG. 5, the determined zone is preferably a tridimensional zone defining one optical plate having a refractive index higher than the refractive index of the outside environment.

Advantageously the modified reflective index of the optical plate is equal to 1.6.

Such structure formed by the optical plate having a refractive index higher than the refractive index of the outside environment allows having a full reflexion on the plate surface for light having an incidence higher than:

$$θ = {sin}^{- 1} ( \frac{{n}_{outside}}{{n}_{o p tical plate}} )$$

For example the pattern structure can be a plurality of distributed Bragg mirrors designed to output light for a chosen specific wavelength.

Advantageously, the pattern forms flat mirrors or curved mirrors, so that virtual image output by Bragg mirror can be seen by the user at a distance depending of the mirrors curvature

Advantageously, the structure is designed to reflect 3 wavelengths so that virtual images can be RGB images.

According to another preferred embodiment of the invention illustrated on FIG. 3, the method further comprises:
a first ophthalmic lens providing step S20; and
a modified optical element adding step S22.

During the first ophthalmic lens providing step S20, a first ophthalmic lens is provided. The first ophthalmic lens has a first optical function. The first ophthalmic lens comprises a first face and a second face opposed to the first face, the second face being the face intended to be the closest to the wearer's eye when the first ophthalmic lens is placed in front of the wearer's eye.

During the modified optical element adding step S22, the modified optical element is added to the first ophthalmic lens so as to form the ophthalmic lens having a desired optical function adapted to the wearer after the modifying step.

The modified optical element is the optical element wherein the refractive index of the first material in the determined zone is modified with focused femtosecond laser pulses according to data.

For example, the modified optical element is a patch glued on the first ophthalmic lens to form the ophthalmic lens having the desired optical function adapted to a prescription of the wearer.

While the foregoing examples have been described with reference to the manufacture of an ophthalmic lens, it will be appreciated that the method of the invention may be applied more generally to the manufacture of other types of optical lens, for example optical lens used in telescopes and the like, car headlight, micro lenses solar panels.

Many further modifications and variations will suggest themselves to those skilled in the art upon making reference to the foregoing illustrative embodiments, which are given by way of example only and which are not intended to limit the scope of the invention, that being determined solely by the appended claims.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used. Any reference signs in the claims should not be construed as limiting the scope of the invention.

1. A method for manufacturing an ophthalmic lens for eyeglasses intended to be placed in front of an eye of a wearer, the ophthalmic lens having a desired optical function comprising a dioptric function adapted to a prescription of the wearer, the method comprising:
providing an optical element made of a first material having a first refractive index, the optical element being intended to be modified to manufacture the ophthalmic lens,
providing data relative to the modification of the optical element enabling to obtain the desired optical function,
determining at least one zone in the first material based on data, and
modifying the refractive index of the first material to form a pattern in the determined zone with focused femtosecond laser pulses according to data so as to obtain an ophthalmic lens having the desired optical function.

2. The method according to claim 1, wherein the data comprise:
data relative to variation of spherical, cylinder and/or prismatic power to be applied to the optical element, and/or
data relative to variation of the optical design to be applied to the optical element, and/or
data relative to an additional dioptric function to be applied to the optical element.

3. The method according to claim 1, wherein the pattern comprises superimposed Fresnel layers.

4. The method according to claim 1, wherein the pattern comprises an interferential element.

5. The method according to claim 1, wherein the optical element is an initial ophthalmic lens having an initial optical function adapted to a previous prescription of the wearer and the refractive index of the first material is modified so as to obtain an ophthalmic lens having the desired optical function adapted to the current prescription of the wearer.

6. The method according to claim 5, further comprising:
measuring the optical element;
determining data relative to the modification of the optical element enabling to obtain the desired optical function based at least on the measurement so as to obtain an ophthalmic lens having a dioptric function adapted to the current prescription.

7. The method according to claim 5, wherein the optical element is a semi-finished lens blank or a lens blank comprising a front face and a back face opposed to the front face, the back face being the face intended to be the closest to the wearer's eye when the ophthalmic lens is placed in front of the wearer's eye.

8. The method according to claim 7, wherein the determined zone is a tridimensional zone defining a plurality of layers wherein the refractive index is modified during the modifying step, each layer being substantially parallel to the front face and localized at an average distance from the front face, and during the modification step, the refractive index of the first material in the determined zone is successively modified with focused femtosecond laser pulses from the most distant layers of the front face to the least distant layers of the front face.

9. The method according to claim 1, wherein the size of the focused femtosecond laser pulses is comprised between 0.5 μm and 1.5 μm.

10. The method according to claim 1, wherein the method further comprises:
providing a first ophthalmic lens having a first optical function and comprising a first face and a second face opposed to the first face, the second face being the face intended to be the closest to the wearer's eye when the first ophthalmic lens is placed in front of the wearer's eye; and
after the modifying step, adding the modified optical element to the first ophthalmic lens so as to form the ophthalmic lens having a desired optical function adapted to the wearer;
wherein the modified optical element is the optical element wherein the refractive index of the first material in the determined zone is modified with focused femtosecond laser pulses according to data.

11. The method according to claim 1, wherein the method further comprises:
applying the pattern to peripheral regions of the lens, and
leaving a center region of the lens free of such pattern, the center region of the lens being intended to be in front of a pupil of the wearer once mounted within a headwear and worn by the wearer.

12. The method according to claim 11, wherein the method further comprises: applying the pattern in a bottom part of the lens intended to be a near vision zone of the lens.

13. The method according to claim 12, wherein the method further comprises: applying the pattern such that it forms a multiplicity of optical elements, each optical element of the multiplicity of optical elements individually having a dioptric function.

14. An ophthalmic lens for eyeglasses intended to be placed in front of an eye of a wearer, the ophthalmic lens having a desired optical function comprising a dioptric function adapted to a prescription of the wearer and being manufactured from an optical element made of a first material having a first refractive index by modifying the refractive index to form a pattern with focused femtosecond laser pulses so as to obtain the ophthalmic lens having the desired optical function.

15. The ophthalmic lens for eyeglasses according to claim 14, wherein the pattern is limited to peripheral regions of the lens, leaving a center region of the lens free of such pattern, the center region of the lens being intended to be in front of a pupil of a wearer once mounted within a headwear and worn by a wearer.

16. An apparatus for manufacturing an ophthalmic lens intended to be placed in front of an eye of a wearer, the ophthalmic lens having a desired optical function comprising a dioptric function adapted to a prescription of the wearer, the apparatus comprising:
means for providing an optical element made of a first material having a first refractive index, the optical element being intended to be modified to manufacture the ophthalmic lens,
means for providing data relative to the modification of the optical element enabling to obtain the desired optical function,
means for determining at least one zone in the first material based on data, and
means for modifying the refractive index of the first material to form a pattern in the determined zone with focused femtosecond laser pulses according to data so as to obtain an ophthalmic lens having the desired optical function.

17. The method of claim 4, wherein the interferential element is an antireflective coating or a reflective coating or a hologram or an optical waveguide.

18. The method according to claim 2, wherein the pattern comprises superimposed Fresnel layers.

19. The method according to claim 2, wherein the pattern comprises an interferential element.

20. The method according to claim 3, wherein the pattern comprises an interferential element.
